(19) United States
(12) Patent Application Publication
(10) Pub. No.: US 2024/0184310 A1
(43) Pub. Date: Jun. 6, 2024

(54) Self-Moving Robot Charging System and Self-Moving Robot Charging Method

(71) Applicants: Suzhou Cleva Precision Machinery and Technology Co., Ltd., Suzhou City, Jiangsu Province (CN); SKYBEST ELECTRIC APPLIANCE (SUZHOU) CO., LTD., Suzhou, Jiangsu (CN)

(72) Inventors: Shaoming Zhu, Suzhou (CN); Xue Ren, Suzhou (CN)

(21) Appl. No.: 17/777,390

(22) PCT Filed: Nov. 24, 2021
(86) PCT No.: PCT/CN2021/132774

§ 371 Date: May 17, 2022

(30) Foreign Application Priority Data
Nov. 24, 2020 (CN) 202011330014.1

(51) Int. Cl. G05D 1/646; G05D 1/661; G05D 111/30

(52) U.S. Cl. CPC G05D 1/646; G05D 1/661; G05D 2111/36

(57) ABSTRACT

The disclosure provides a self-moving robot charging system and a self-moving robot charging method. The self-moving robot charging system enables the self-moving robot to find the charging station faster by using the charging station guideline surrounding the charging station and cooperating with the positioning system of the self-moving robot, saving the time to find a charging station and increasing the power usage of the robot, and there are no restrictions on the installation position of the charging station and the starting position of the self-moving robot, which can cover more usage scenarios.

### TECHNICAL FIELD

The disclosure relates to the field of intelligent control, in particular to a self-moving robot charging system and a self-moving robot charging method.

### BACKGROUND

With the continuous development of science and technology, various automatic working equipment has begun to slowly enter people's lives, such as lawn mowers. This kind of automatic working equipment has a walking device, a working device and an automatic control device, so that the automatic working equipment can be independent from people's operation, automatically walk and perform work within a certain range, and when the energy of the energy storage device of the automatic working equipment is insufficient, it can automatically return to the charging station unit to recharge and then keep working.

The charging system of the robot in the prior art is to first build a charging station guideline around the entire working region, the charging station guideline is connected to the charging station, and the robot walks along the charging station guideline to find the charging station for docking and charging. The whole process is time-consuming and labor-intensive. The charging station guideline laid along the entire working region will make the robot find the charging station guideline without the principle of proximity, and the robot needs to move along the boundary of the entire working region after finding the boundary line of the charging station. In this way, the process of finding the charging station for the robot is cumbersome and long, and the power consumption of the robot is increased. Moreover, using this method to set the boundary line, the charging station can only be set in some fixed positions.

### SUMMARY

The purpose of the present disclosure is to provide a self-moving robot charging system and a self-moving robot charging method.

A self-moving robot charging system comprises a self-moving robot and a charging station set in a working region or at the edge of the working region of the self-moving robot, and the self-moving robot is provided with a charging connection structure matching the charging station, and at least one detection sensor, wherein:
the self-moving robotic charging system further comprises a charging station guideline electrically connected to the charging station and forming a closed loop via the electrical connection with the charging station, the closed loop defining a first region, the first region is located in the working region and at least surrounds the side of the charging station exposed to the working region;
the self-moving robot further comprises a control module provided with a positioning system, and the control module is at least configured to control the self-moving robot to move toward the direction of the charging station guideline through the positioning system, and the detection sensor is configured to detect and identify the signal sent from the charging station guideline.

As a further improvement of the present disclosure, the charging station guideline comprises an outer contour section and two connecting sections, and the outer contour section is in the shape of a continuous line segment with an opening, which at least surrounds the side of the charging station exposed to the working region, the two end points of the outer contour section are respectively connected to the charging station through the connecting section, and the outer contour section and the connecting section are surrounded to form a first region.

As a further improvement of the present disclosure, the width of the self-moving robot is W, and at least one of the detection sensors is symmetrically arranged on both sides of the central axis of the self-moving robot in the width direction, and the distance between the detection sensors symmetrically arranged on both sides is M.

As a further improvement of the present disclosure, one side of the charging station is in contact with the boundary of the working region, and the outer contour section surrounds the side of the charging station that is not in contact with the boundary of the working region.

As a further improvement of the present disclosure, the distance between the two ends of the outer contour section and the boundary of the working region is X, ½W<X<½(W+M), and the distance between the connecting section and the boundary of the working region is greater than ½W.

As a further improvement of the present disclosure, the charging station is located in the working region and is not in contact with the boundary of the working region, and the outer contour section surrounds all sides of the charging station.

As a further improvement of the present disclosure, the distance between the two ends of the outer contour section is Y, ½M<Y<M, and the distance between the connecting sections is greater than ½M.

As a further improvement of the present disclosure, the charging station is provided with a charging interface on at least one side thereof, and at least one of the connecting sections is connected to the side of the charging station provided with the charging interface to form a guiding section, the length of the self-moving robot is L, and the length of the guiding section is not less than L.

As a further improvement of the present disclosure, the charging station is provided with the charging interface on one side thereof, and the connecting section connected to the charging station forms a guiding section, and the detection sensor and the control module are further configured to control the self-moving robot to move in the direction toward the guiding section after the self-moving robot is controlled to contact the charging boundary line.

As a further improvement of the present disclosure, the length of the guiding section is 2L, and the distance between the outer contour section and the charging station is not greater than 2L.

The present disclosure also provides a charging method for a self-moving robot, comprising the steps of:
drive the self-moving robot to move from the current position to the direction of the charging station;
after the self-moving robot moves to the charging station guideline, the detection sensor detects and identifies the charging station guideline;
the self-moving robot moves along the path of the charging station guideline, and the charging connection structure is aligned and connected to the charging station.

The beneficial effects of the present disclosure are as follows: the self-moving robot charging system provided by the present disclosure enables the self-moving robot to find the charging station faster by using the charging station guideline surrounding the charging station and cooperating with the positioning system of the self-moving robot, saving the time to find a charging station and increasing the power usage of the robot, and there are no restrictions on the installation position of the charging station and the starting position of the self-moving robot, which can cover more usage scenarios.

### BRIEF DESCRIPTION OF THE DRAWINGS

FIG. 1 is a schematic diagram of a self-moving robot in an embodiment of the present disclosure.

FIG. 2 is a schematic diagram of the wiring of the charging station guideline in embodiment 1 of the present disclosure.

FIG. 3 is a schematic diagram of the wiring of the charging station guideline in embodiment 2 of the present disclosure.

FIG. 4 is a schematic diagram of the wiring of the charging station guideline in embodiment 3 of the present disclosure.

FIG. 5 is a schematic diagram of the wiring of the charging station guideline in embodiment 4 of the present disclosure.

### DETAILED DESCRIPTION

In order to make the purpose, technical solutions and advantages of the present application clearer, the technical solutions of the present application will be clearly and completely described below in conjunction with the specific embodiments of the present application and the corresponding drawings. Obviously, the described embodiments are only a part of the embodiments of the present application, but not all of the embodiments. Based on the embodiments in the present application, all other embodiments obtained by those of ordinary skill in the art without creative work fall within the protection scope of the present application.

Embodiments of the present disclosure are described in detail below, examples of which are illustrated in the accompanying drawings, wherein the same or similar reference numerals refer to the same or similar elements or elements having the same or similar functions throughout. The embodiments described below with reference to the accompanying drawings are exemplary, only used to explain the present disclosure, and should not be construed as a limitation of the present disclosure.

For the convenience of description, the term is used to describe the relative position in space in the context, such as “upper”, “lower”, “rear”, “front”, etc., used to describe the relationship of one element or feature shown in the drawings to another element or feature. The term spatially relative position may comprise different orientations of the device in use or operation other than the orientation shown in the figures. For example, if the device in the figures is turned over, elements described as “below” or “above” other elements or features would then be oriented “below” or “above” the other elements or features. Thus, the exemplary term “below” can encompass both spatial orientations of below and above.

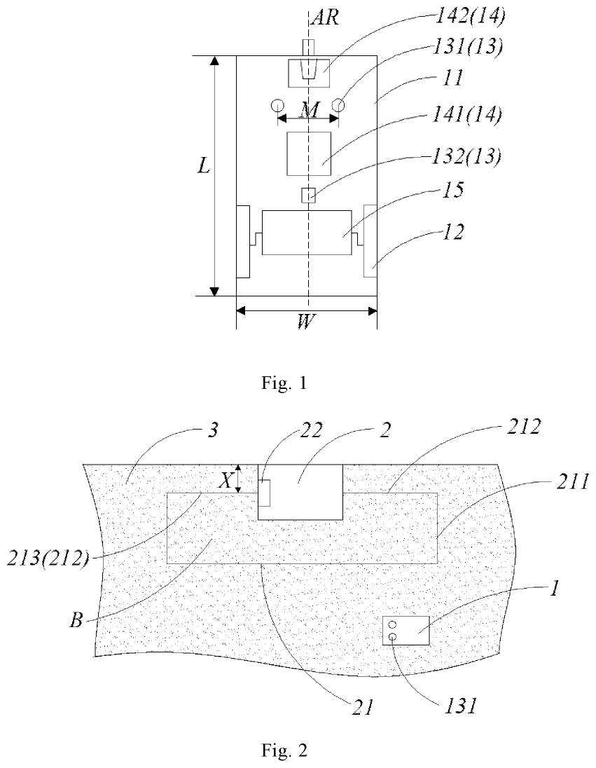

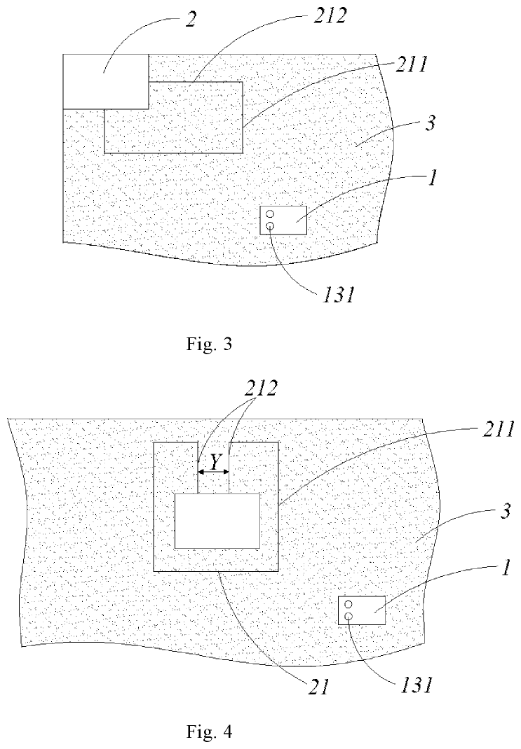

As shown in FIG. 1 and FIG. 2, the present disclosure provides a charging system for a self-moving robot 1, including a self-moving robot 1 and a charging station 2 arranged in a working region 3.

The self-moving robot 1 may be a lawn mower, or an automatic vacuum cleaner, etc., which automatically walks in the working region 3 for mowing or vacuuming. In the specific example of the present disclosure, the self-moving robot 1 is a self-moving robot mower 1, correspondingly, the working region 3 can be a lawn. Of course, the self-moving robot 1 is not limited to lawn mowers and vacuum cleaners, but can also be other equipment, such as spraying equipment, snow removal equipment, monitoring equipment and other equipment suitable for unattended operation.

As shown in FIG. 1, in the specific embodiment of the present disclosure, the self-moving robot 1 has a length of L and a width of W. The self-moving robot 1 comprises: a body 11, a walking module 12 arranged on the body 11, and a boundary detection module 13, an energy module 14 and a control module 15. In addition, the self-moving robot 1 also comprises a work module, which is used to perform specific work tasks of the lawn mower. The work module comprises a mowing blade, a cutting motor, etc., and may also comprise parts that can optimize or adjust the mowing effect like a mowing height adjustment mechanism, etc.

The walking module 12 is used to drive the self-moving robot 1 to walk and turn in the working region 3, and is usually composed of a wheel set installed on the self-moving robot mower and a drive motor that drives the wheel set to travel.

The boundary detection module 13 is used to detect the relative positional relationship between the self-moving robot mower 1 and other objects in the working region 3 such as the charging station 2, and the relative positional relationship may specifically comprise one or more of distance, angle, and orientation inside and outside the boundary line.

The composition and principle of the boundary detection module 13 can be various, such as infrared type, ultrasonic type, collision detection type, magnetic induction type, etc. The installation positions and numbers of sensors and corresponding signal generating devices are also various.

Specifically, in this embodiment, the boundary detection module 13 comprises two detection sensors 131 symmetrically arranged on both sides of the central axis AR of the self-moving robot 1 in the width direction, and the distance between the two detection sensors 131 is M.

In some other embodiments of the present disclosure, the number and arrangement of the detection sensors 131 can also be adjusted, for example, one detection sensor 131 is arranged on the central axis AR of the self-moving robot 1 in the width direction.

Further, in some embodiments of the present disclosure, the boundary detection module 13 further comprises a camera 132, which is at least configured to identify and avoid the charging station 2, so that during normal operation, the self-moving robot 1 will not collide with the charging station 2.

The energy module 14 is used to provide energy for various tasks of the self-moving robot 1, and comprises a rechargeable battery 141 and a charging connection structure 142. The charging connection structure 142 is generally a charging electrode sheet that can be exposed outside the lawn-mowing self-moving robot mower 1.

As shown in FIG. 2, the charging station 2 is located in the working region 3 and is connected to the commercial power or other power supply system for the self-moving robot 1 to returning and charging. The charging connection structure 142 of the self-moving robot 1 matches the charging station 2.

The charging system of the self-moving robot 1 further comprises a charging station guideline 21 arranged around the charging station 2. The charging station guideline 21 is arranged in the working region 3, and the charging station guideline 21 is electrically connected with the charging station 2 to form a closed loop. The signal generator in the charging station 2 makes the charging station guideline 21 send out a signal, the detection sensor 131 detects the signal, and the control module 15 adjusts the posture and walking path of the auto-walking robot 1 according to the signal.

Further, the control module 15 also comprises a positioning system (not shown in the figure), the positioning system may be a positioning system such as GPS, UWB or Zigbee, and the control module 15 is at least configured to control the self-moving robot 1 to move toward the charging station guideline 21. The self-moving robot 1 can identify the position of the charging station 2 through the location information of the charging station 2 recorded in the positioning system in advance, or through the position signal transmitter in the charging station 2, etc., and when the control module 15 judges that the self-moving robot 1 needs charging, control the self-moving robot 1 to move toward the charging station 2. The charging station guideline 21 sends a signal. After the self-moving robot 1 moving to the charging boundary line, the self-moving robot 1 moves along the trajectory of the charging station guideline 21 and enters the charging station 2 to connect the charging connection structure 142 to the charging station 2 in alignment.

The closed loop defines a first region B which is located within the working region 3 and at least partially surrounds the charging station 2.

The self-moving robot 1 first moves toward the charging station 2 through the positioning system, and then moves along the charging station guideline 21 laid around the charging station 2 to connect with the charging station 2, so that the self-moving robot 1 can find the charging station 2 more quickly, saving the time required to find the charging station 2 and increasing the power usage of the robot, and there are no restrictions on the installation position of the charging station 2, and no restrictions on the starting position of the self-moving robot 1, which can cover more usage scenarios.

Further, the charging station guideline 21 comprises an outer contour section 211 and two connecting sections 212. The outer contour section 211 is in the shape of a continuous line segment with an opening. The two ends of the outer contour section 211 are respectively connected to the charging station 2 through the connecting section 212, and the outer contour section 211 and the connecting section 212 are surrounded to form a first region B, and the outer contour section 211 at least surrounds the side of the charging station 2 exposed to the working region 3, thereby, it is ensured that the self-moving robot 1 moves toward the charging station 2 from any position in the working region 3, and will first contact the charging station guideline 21, and then move along its trajectory, which improves the accuracy of path finding and selection. The outer contour section and the connecting section are surrounded to form a first region, the region of the first region is smaller than the region of the working region, and the region of the first region B is smaller than the region of the working region 3. On the one hand, the time required for the robot to find the charging station can be reduced; on the other hand, the length of the charging station guideline to be laid can be reduced, thereby reducing the laying cost and the possibility of damage to the charging station guideline 21.

It can be understood that the surrounding mentioned here refers to substantially surrounding. In some embodiments, the outer contour section 211 may have an opening or is partially exposed at a position close to the edge of the working region 3 to meet the movement requirements of the self-moving robot 1, but it does not affect the realization of the technical effect that the outer contour section 211 surrounds the charging station 2 and makes the self-moving robot 1 contact the charging station guideline 21 first.

Further, the distance between the outer contour section 211 and the charging station 2 is X, where X>½W. Since the detection sensors 131 are evenly set on both sides of the central axis AR, that is, when the self-moving robot 1 moves on the charging station guideline 21, the center axis AR coincides with the charging station guideline 21, and the distance between the outer contour section 211 and the charging station 2 is limited to be greater than ½W, which can prevent the self-moving robot 1 from colliding with the charging station 2 when moving.

In this embodiment, at least one side surface of the charging station 2 is provided with the charging interface 22, and at least one connecting section 212 is connected to the side surface of the charging station 2 provided with the charging interface 22 to form a guiding section 213.

Further, the length of the self-moving robot 1 is L, and the length of the guiding section 213 is not less than L. The self-moving robot 1 adjusts the orientation of the body by moving along the guiding section 213, so that the charging connection structure 142 is connected to the charging interface 22 of the charging station 2 in alignment.

Preferably, the length of the guiding section 213 is 2L to ensure that the orientation of the body can be completely adjusted, so that the self-moving robot 1 can be accurately docked with the charging station 2.

Further, the distance between the outer contour section 211 and the charging station 2 is not greater than 2L, so that while meeting the length requirement of the guiding section 213, the length of the charging station guideline 21 can be reduced as much as possible, and reduce the cost of laying the charging station guideline 21, and reduce the possibility of damage to the charging station guideline 21.

Further, in some embodiments of the present disclosure, one side of the charging station 2 is provided with a charging interface 22, and the connecting section 212 connected to it forms the guiding section 213, the detection sensor 131 and the control module 15 is further configured to control the self-moving robot 1 to move in the direction toward the guiding section 213 after contacting the charging boundary line, so as to further reduce the time required for the self-moving robot 1 to find the charging station 2.

In other embodiments of the present disclosure, the charging station 2 is provided with a guiding device such as a magnetic control component. When the self-moving robot 1 is transported along the charging station guideline 21 to the vicinity of the guiding device of the charging station 2, the direction is automatically adjusted, the charging connection structure 142 is docked with the charging station 2. The charging station 2 and the self-moving robot 1 are also charged by the wireless charging device, so as to further reduce the requirement of the self-moving robot 1 on the accuracy of the movement path.

The wiring mode of the charging station guide wire 21 in the specific embodiment of the present disclosure will be described in detail below.

As shown in FIG. 2, in embodiment 1, the planar shape of the charging station 2 can be approximately regarded as a rectangle, and one side of the charging station 2 is connected to the boundary of the working region 3, and the boundary of the working region 3 is provided with obstacles such as walls or fences.

The outer contour section 211 encloses the side of the charging station 2 that does not adjoin the boundary of the working region 3.

Further, the distance between the two ends of the outer contour section 211 and the boundary of the working region 3 is X, ½W<X<½(W+M), and the distance between the connecting section 212 and the boundary of the working region 3 is greater than ½W. Therefore, when the self-moving robot 1 moves along the boundary of the working region 3 to the charging station guideline 21, it will not rub against obstacles, or directly collide with the charging station 2 without touching the charging station guideline 21.

As shown in the figure, in embodiment 2, the planar shape of the charging station 2 can be regarded as a rectangle. When there is an region with an approximate right angle at the corner of the boundary of the working region 3, the charging station 2 is set at the corner of the working region 3, that is, the two sides of the charging station 2 are connected to the boundary of the working region 3, and the boundary of the working region 3 is provided with obstacles such as walls or fences.

The distance limitation between the two ends of the outer contour section 211 and the boundary of the working region 3 is similar to that in embodiment 1. By arranging the charging station 2 at the corner of the working region 3, the length of the laid charging station guideline 21 can be further reduced.

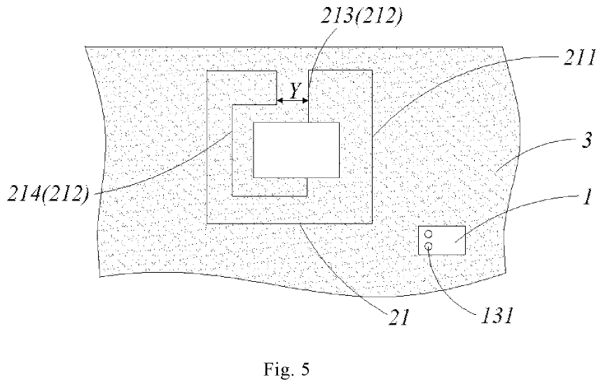

As shown in FIG. 4 and FIG. 5, in embodiment 3, the planar shape of the charging station 2 can be approximately regarded as a rectangle. The charging station 2 is located in the working region 3 and does not contact the boundary of the working region 3. The outer contour section 211 surrounds all sides of charging station 2.

The distance between the two ends of the outer contour section 211 is Y, ½M<Y<M, and the distance between the connecting sections 212 is greater than ½M, that is, an opening with a length Y is formed on the outer contour section 211. When the outer contour section 211 needs to surround all sides of the charging station 2, an opening with a defined length greater than ½M is formed in the outer contour section 211, so as to prevent the self-moving robot 1 from continuing to circulate along the outer contour section 211, meanwhile, its length is controlled within M to ensure that the self-moving robot 1 will not directly enter the charging station guideline 21 from the opening of the outer contour section 211 without contacting it.

According to the difference in the structure, charging method, and charging connection method of the charging station 2, the two connecting sections 212 can be connected to the same side of the charging station 2 at the same time or be connected to two sides respectively.

As shown in FIG. 4, one connecting section 212 is connected to one side of the charging station 2 to form a guiding section 213, and the other connecting section 212 is connected to the opposite side of the charging station 2 to form an inner contour section 214, and the distance between the inner contour section 214 and the outer contour section 211 is greater than ½M, so as to avoid the situation of deviating from the path when the self-moving robot 1 moves on the outer contour section 211 and the inner contour section 214.

The present disclosure also provides a charging method for the self-moving robot 1, comprising the steps of:
drive the self-moving robot 1 to move toward charging station 2;
after the self-moving robot 1 moves to the charging station guideline 21, the detection sensor 131 detects and identifies the charging station guideline 21;
the self-moving robot 1 moves along the path of the charging station guideline 21, and the charging connection structure 142 thereof is connected to the charging station 2 in alignment.

In summary, the self-moving robot charging system provided by the present disclosure enables the self-moving robot to find the charging station faster by using the charging station guideline surrounding the charging station and cooperating with the positioning system of the self-moving robot, saving the time to find a charging station and increasing the power usage of the robot, and there are no restrictions on the installation position of the charging station and the starting position of the self-moving robot, which can cover more usage scenarios.

It should be understood that although this specification is described in terms of embodiments, not each embodiment only comprises an independent technical solution. This description in the specification is only for the sake of clarity, and those skilled in the art should take the specification as a whole, and each technical solution in the embodiments can also be appropriately combined to form other embodiments that can be understood by those skilled in the art.

The series of detailed descriptions listed above are only specific descriptions for the feasible embodiments of the present disclosure, they are not intended to limit the protection scope of the present disclosure. Any equivalent embodiments or changes made without departing from the technical spirit of the present disclosure should be comprised within the protection scope of the present disclosure.

1. A self-moving robot charging system, comprising:
a self-moving robot and a charging station set in a working region or at the edge of the working region of the self-moving robot, the self-moving robot is provided with a charging connection structure matching the charging station, and at least one detection sensor;
the self-moving robotic charging system further includes a charging station guideline electrically connected to the charging station and forming a closed loop via the electrical connection with the charging station, the closed loop defining a first region, the first region is located in the working region and at least surrounds the charging station partially; and
the self-moving robot further includes a control module provided with a positioning system, and the control module is at least configured to control the self-moving robot to move toward the direction of the charging station guideline through the positioning system, and the detection sensor is configured to detect and identify the signal sent from the charging station guideline.

2. The self-moving robot charging system according to claim 1, wherein the charging station guideline includes an outer contour section and two connecting sections, and the outer contour section is in the shape of a continuous line segment with an opening, which at least surrounds the side of the charging station exposed to the working region, the two end points of the outer contour section are respectively connected to the charging station through the connecting section, and the outer contour section and the connecting section are surrounded to form a first region, and the region of the first region is smaller than the region of the working region.

3. The self-moving robot charging system according to claim 2, wherein the width of the self-moving robot is W, and at least one of the detection sensors is symmetrically arranged on both sides of the central axis of the self-moving robot in the width direction, and the distance between the detection sensors symmetrically arranged on both sides is M.

4. The self-moving robot charging system according to claim 3, wherein one side of the charging station is in contact with the boundary of the working region, and the outer contour section surrounds the side of the charging station that is not in contact with the boundary of the working region.

5. The self-moving robot charging system according to claim 4, wherein the distance between the two ends of the outer contour section and the boundary of the working region is X, ½W<X<½(W+M), and the distance between the connecting section and the boundary of the working region is greater than ½W.

6. The self-moving robot charging system according to claim 3, wherein the charging station is located in the working region and is not in contact with the boundary of the working region, and the outer contour section surrounds all sides of the charging station.

7. The self-moving robot charging system according to claim 6, wherein the distance between the two ends of the outer contour section is Y, ½M<Y<M, and the distance between the connecting sections is greater than ½M.

8. The self-moving robot charging system according to claim 5, wherein the charging station is provided with a charging interface on at least one side thereof, and at least one of the connecting sections is connected to the side of the charging station provided with the charging interface to form a guiding section, the length of the self-moving robot is L, and the length of the guiding section is not less than L.

9. The self-moving robot charging system according to claim 8, wherein the charging station is provided with the charging interface on one side thereof, and the connecting section connected to the charging station forms the guiding section, and the detection sensor and the control module are further configured to control the self-moving robot to move in the direction toward the guiding section after the self-moving robot is controlled to contact the charging boundary line.

10. The self-moving robot charging system according to claim 9, wherein the length of the guiding section is 2L, and the distance between the outer contour section and the charging station is not greater than 2L.

11. A charging method for a self-moving robot, comprising the steps of:
driving the self-moving robot to move from the current position to the direction of the charging station;
after the self-moving robot moves to the charging station guideline, using the detection sensor to detect and identify the charging station guideline; and
moving the self-moving robot along the path of the charging station guideline, the charging connection structure being aligned and connected to the charging station.

12. The self-moving robot charging system according to claim 7, wherein the charging station is provided with a charging interface on at least one side thereof, and at least one of the connecting sections is connected to the side of the charging station provided with the charging interface to form a guiding section, the length of the self-moving robot is L, and the length of the guiding section is not less than L.

13. The self-moving robot charging system according to claim 12, wherein the charging station is provided with the charging interface on one side thereof, and the connecting section connected to the charging station forms the guiding section, and the detection sensor and the control module are further configured to control the self-moving robot to move in the direction toward the guiding section after the self-moving robot is controlled to contact the charging boundary line.

14. The self-moving robot charging system according to claim 13, wherein the length of the guiding section is 2L, and the distance between the outer contour section and the charging station is not greater than 2L.
